(19) United States
(12) Patent Application Publication
(10) Pub. No.: US 2025/0307823 A1
(43) Pub. Date: Oct. 2, 2025

(54) SYSTEM FOR SYSTEM FOR CREATING, STORING, AND PORTABLY UTILIZING VERIFIED DIGITAL IDENTITIES

(71) Applicant: Scientia Potentia Est II, LLC, Charleston, SC (US)

(72) Inventors: Jeremy Blackburn, Charleston, SC (US); Timothy Hines, Frisco, TX (US); Matthew Koepp, Frisco, TX (US)

(73) Assignee: Scientia Potentia Est II, LLC, Charleston, SC (US)

(21) Appl. No.: 19/238,009

(22) Filed: Jun. 13, 2025

Related U.S. Application Data
(63) Continuation-in-part of application No. 19/032,916, filed on Jan. 21, 2025.
Application No. 19/032,916 is a continuation-in-part of application No. 17/697,839, filed on Mar. 17, 2022, now abandoned.
Application No. 17/697,839 is a continuation-in-part of application No. 17/686,502, filed on Mar. 4, 2022, now Pat. No. 11,610,202.
Application No. 17/686,502 is a continuation-in-part of application No. 17/566,957, filed on Dec. 31, 2021, now Pat. No. 12,321,940.
Application No. 17/566,957 is a continuation-in-part of application No. 17/561,827, filed on Dec. 24, 2021, now Pat. No. 11,574,319.
Application No. 17/561,827 is a continuation-in-part of application No. 17/531,746, filed on Nov. 20, 2021, now Pat. No. 11,482,325.
Application No. 17/531,746 is a continuation-in-part of application No. 17/531,598, filed on Nov. 19, 2021, now abandoned.
Application No. 17/531,598 is a continuation-in-part of application No. 17/344,043, filed on Jun. 10, 2021, now abandoned.
Application No. 17/344,043 is a continuation-in-part of application No. 17/230,911, filed on Apr. 14, 2021, now Pat. No. 11,288,761.
Application No. 17/230,911 is a continuation-in-part of application No. 17/176,056, filed on Feb. 15, 2021, now Pat. No. 11,288,308.
Application No. 17/176,056 is a continuation-in-part of application No. 17/128,084, filed on Dec. 19, 2020, now Pat. No. 11,521,157.
Application No. 17/128,084 is a continuation-in-part of application No. 16/997,840, filed on Aug. 19, 2020, now Pat. No. 11,449,949.
Application No. 16/997,840 is a continuation-in-part of application No. 16/994,585, filed on Aug. 15, 2020, now Pat. No. 11,232,652.
Application No. 16/994,585 is a continuation-in-part of application No. 16/991,916, filed on Aug. 12, 2020, now Pat. No. 11,216,823.
Application No. 16/991,916 is a continuation-in-part of application No. 16/876,080, filed on May 17, 2020, now Pat. No. 11,423,360.
Application No. 16/876,080 is a continuation-in-part of application No. 16/810,782, filed on Mar. 5, 2020, now Pat. No. 11,216,781.
Application No. 16/810,782 is a continuation-in-part of application No. 16/510,634, filed on Jul. 12, 2019, now Pat. No. 10,713,737.
Application No. 16/510,634 is a continuation-in-part of application No. 16/452,076, filed on Jun. 25, 2019, now abandoned.
Application No. 16/810,782 is a continuation-in-part of application No. 16/510,642, filed on Jul. 12, 2019, now Pat. No. 11,216,772.
Application No. 16/510,642 is a continuation-in-part of application No. 16/452,076, filed on Jun. 25, 2019, now abandoned.

(51) Int. Cl. G06Q 20/40; G06Q 20/38

(52) U.S. Cl. CPC G06Q 20/40145; G06Q 20/3825; G06Q 20/3827

(57) ABSTRACT

This system provides a computerized method for executing a legally binding digital, comprising: creating a unique tokenized representation of the Pactvera using a non-fungible token standard; embedding a payment value or digital consideration into said token; verifying parties to the Pactvera through biometric authentication and decentralized identity (ChainIT ID) validated against an authoritative source; recording the Pactvera Validation with metadata including time, location, device ID, age verification, and jurisdiction; recording immutable authorship and origin metadata of the Pactvera, including verification of the creator and presenter through Pactvera Validation; validating the original token instance and execution context via a Business Rules Engine (BRE); and releasing payment or conditional consideration via smart contract upon satisfaction of predefined conditions. The invention further enables integration with electronic recording systems for real property transactions in compliance with the Uniform Real Property Electronic Recording Act and produces tamper-proof audit trails suitable for litigation and regulatory use.

### BACKGROUND OF THE INVENTION

### 1) Field of Invention

The present invention relates generally to digital transaction validation and more specifically to systems and methods for embedding value into tokenized, immutable transactions and effectuating conditional consideration to participants based on verification of execution criteria via smart contracts and autonomous workflows to enable the creation of legally enforceable transaction by incorporating the required legal elements of offer, acceptance, mutual assent, consideration, capacity, and legality, validated through biometrics and enforced by a Business Rules Engine (BRE). This new and novel transaction memorialization and implementation is generally called a Pactvera.

### 2) Description of the Related Art

Electronic signature platforms have become increasingly prevalent in recent years, streamlining document execution processes across various industries. Like traditional contracts, these electronic signatures are used for representations of transactions and not necessarily for implementation of the transaction itself. Electronic signature platforms simply take the place of the traditional ink signature, seal or stamp of the executing party. These platforms are designed to allow users to “sign” documents digitally, reducing the need for physical paperwork and expediting transactions.

However, existing solutions lack robust verification mechanisms for these signatures putting into question authority, authorization, authenticity and other requirements of a valid “signature.” and struggle to provide a comprehensive audit trail of document interactions. Traditional e-signature services typically rely on centralized databases and focus primarily on static document acknowledgment using email-verified user credentials, to store user information and document metadata. This centralized approach can create single points of failure and potential security vulnerabilities. Additionally, the reliance on current e-signature platforms verify identities and document authenticity does not meet certain industries or regulatory requirements. For example, in 2016, a United States Bankruptcy Judge in California ruled that while a well know e-signature platform may be appropriate in many business settings, overall, it does not constitute a replacement for original signatures on legal documents and the like.

Current platforms also face challenges in capturing and securely storing detailed information about document interactions. While basic metadata such as timestamps and IP addresses may be recorded, more nuanced data about the signing process, including the specific device used or the precise location of the signer, is often not captured or stored in a tamper-resistant manner. Furthermore, existing solutions generally lack integration with smart contract functionality, limiting their ability to automate complex document workflows or facilitate conditional payments based on specific execution criteria. This gap in functionality can lead to inefficiencies in multi-party agreements or transactions that require precise tracking of document states and participant actions.

Privacy concerns also persist in current e-signature platforms, as users often have limited control over how their personal information is shared or used during the document execution process. The inability to selectively disclose identity attributes while still maintaining verifiability can be problematic in scenarios where privacy is paramount.

Therefore, it is an object of the present system to provide for immutable storage of detailed document interaction data, including who performed an action, what was performed, when the action occurred, where it was performed, and which device was used.

It is another object of the present system to provide for the generation of a validated data tokens (VDT) that encapsulate metadata and are minted as non-fungible tokens, enabling trustless third-party validation and compliance-grade audit trails.

It is another object of the present system to provide for selective metadata disclosure through zero-knowledge verification protocols, enhancing privacy while maintaining verifiability.

It is another object of the present system to provide for integration of business rule enforcement and conditional compensation via smart contracts, allowing for automated workflow management and payment distribution based on document execution events.

### SUMMARY OF THE INVENTION

The present invention provides a computerized system for creating and executing digital transactions using tokenized representations, embedded consideration, blockchain technology and smart contacts to both memorialize a transaction as well as implement the transaction in a digital form. This system addresses limitations of traditional contract creation, execution and verification methods by offering a secure, efficient, and transparent solution. The computerized system creates a unique tokenized item that is both the representation of a transaction as well as the implementation and performance of the transaction using a non-fungible token and embeds consideration into the token. This design allows for the integration of value directly within the digital transaction, enabling automated and conditional transfer of assets or rights.

The system further includes robust identity verification mechanisms, utilizing biometric authentication and decentralized identity validation against authoritative sources. This feature ensures that participants in the digital transaction are accurately identified and authorized to engage in the transaction. Additionally, the invention incorporates a business rules engine to define and enforce execution conditions for the digital transaction. This component enables the system to automatically evaluate and validate various aspects of the transaction, including participant identity, age, jurisdiction, and timing, ensuring compliance with legal and regulatory requirements.

By combining these features with immutable ledger storage and smart contract functionality, the present invention offers a significant advancement over traditional contacts and current in digital signature technology. It provides a secure, verifiable, and automated method for executing and recording transaction and agreements, potentially improving efficiency and reducing fraud in various industries and applications.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A is a block diagram of aspects of the system;

FIG. 1B is a block diagram of aspects of the system;

FIGS. 2 and 3 are diagrams of aspects of the system;

FIGS. 4 and 5 are illustrations of aspects of the system;

FIG. 6 is a flowchart of aspects of the method;

FIG. 7 is a flowchart of aspects of the method;

FIG. 8 is a flowchart of aspects of the method;

FIGS. 9A and 9B are flowcharts of aspects of the method;

FIGS. 10A and 10B are flowcharts of aspects of the method;

The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

The construction designed to carry out the invention will hereinafter be described, together with other features thereof. The invention will be more readily understood from a reading of the following specification and by reference to the accompanying drawings forming a part thereof, wherein an example of the invention is shown and wherein.

The present invention introduces a new construct of digital agreement—termed a “Pactvera”—that combines immutable tokenization, multi-factor identity verification, and conditional logic enforceable via a Business Rules Engine (BRE). Unlike prior systems, Pactvera is not merely a record of signature, but an actionable, attested legal object with embedded conditionality, identity provenance, and programmable enforceability. This transforms the agreement from a static form to a dynamic, legally aware and verifiably executed instrument.

This system provides a novel approach to conducting, implementing, executing and memorializing transactions using digital Pactveras. This approach creates a connection between transaction activities and their formal documentation, reducing discrepancies and improving the accuracy of transaction records

With the digital transactions herein, Pactveras, the system introduces not just a better contract, or signature, system, but a new category of digital execution that fulfills one or more elements of enforceable agreements through verifiable, immutable design. By integrating truth, authority, value, and compliance into a tokenized contract record, the Pactvera provides for litigation resilient evidence of intent and identity, embedded conditional logic for automated value transfer and transaction execution, transparency and auditability for meeting regulatory requirements, and jurisdiction-aware contract formats, The system provides for a Pactvera that is more than just an electronic signature but is a novel and advantageous system for creating, managing, memorializing, effectuating, storage and implementing transactions.

The system can create, retrieve or otherwise use a digital ID such as a ChainIT ID. A ChainIT ID may refer to a unique digital identifier associated with an individual or entity within the system. This identifier may be used to securely link and verify various pieces of information related to the user across different transactions and interactions within the system. In some aspects, the ChainIT ID may incorporate cryptographic elements to enhance security and privacy. The ChainIT ID may serve as a foundational component for managing digital identities, potentially allowing users to control and selectively share their personal information in a decentralized manner. In some cases, the ChainIT ID may be associated with biometric data, transaction history, or other relevant metadata to create a digital identity profile within the system.

This system can include or benefit from a computerized system that may include functionality illustrated by the following steps. The system can create or can use a verified digital ID (e.g., ChainIT ID) with a digital transaction (e.g., Pactvera) that can include computer functionality such as: Capture of biometric data: The system may collect one or more types of biometric information from an individual, such as facial images, fingerprints, iris scans, or voice prints. Verification of physical identification: The system may scan and validate government-issued identification documents like passports or driver's licenses to cross-reference the biometric data. Data extraction and processing: Key information from transaction actions, transaction information, consideration, participants, timing, conditions, physical documents, agreements, and biometric scans may be digitized and processed to create a standardized digital record. Creation of cryptographic hash: The system may generate a unique cryptographic hash of the compiled digital identity information to ensure its integrity. Blockchain registration: The digital ID hash may be recorded on a blockchain or distributed ledger system, providing an immutable timestamp and audit trail. Issuance of digital credential: A digital credential or token representing the validated identity may be issued to the individual, potentially stored in a secure digital wallet. This can be referred to as a ChainIT ID. Integration with verification systems: The ChainIT ID may be linked to various verification systems to enable seamless authentication across different services and locations. Ongoing updates and revocation: The system or a system in which it is in communications may allow for secure updates to the ChainIT ID information over time, as well as mechanisms for revoking or suspending the ChainIT ID if necessary.

As used herein, a transaction includes any binding or legally enforceable agreement, contract, consent, transaction, or verified act between two or more parties, regardless of the format, medium, or mode of creation. A transaction may be expressed in written, verbal, biometric, tokenized, or electronic form, and includes, but is not limited to: traditional contracts, smart contracts, oral agreements with biometric confirmation, digital acknowledgments, tokenized interactions, and authenticated records verified through decentralized identity systems. A transaction may be stored and represented as a physical document, an electronic file, a non-fungible token (NFT), a VDT, or a real-time verifiable event, and may include embedded programmable business logic or conditional payment mechanisms enforced by a BRE. Each Pactvera is intended to be immutable, tamper-evident, and auditable, and may incorporate metadata including authorship, timestamp, geolocation, device ID, and validation context for long-term enforceability and third-party validation. Transaction herein that are Pactvera can, in some jurisdictions, satisfy the essential legal elements of contract formation including offer, acceptance, mutual assent, consideration, legal capacity, and lawful subject matter, and incorporates programmable rules and embedded compliance logic to govern its execution and the effectuation of the subject matter of the Pactvera. A Pactvera can be memorialized, effectuated and stored by this system.

In some jurisdictions, the elements of legally binding contract are verified and included in the Pactvera. These elements can include: Offer: One party makes a clear, definite, and unambiguous offer to do something or refrain from doing something. The offer can include terms (e.g., price, scope, duties) that are capable of being accepted. Acceptance: The other party must unconditionally accept the offer as presented. Acceptance must mirror the offer (the “mirror image rule”) and be communicated to the offeror. With traditional contacts, methods of acceptance may vary (written, verbal, conduct) and must comply with any specified terms in the offer. Consideration: There must be something of value exchanged by each party. This can be: money, services, goods, a promise to act or refrain from acting (including forbearance). Consideration must be mutual and adequate, though courts typically do not evaluate the fairness of the value. Mutual assent (e.g., meeting of the minds) both parties must understand and agree to the essential terms and nature of the contract. This is often established through the exchange of offer and acceptance. Ambiguities or hidden terms can undermine mutual assent. Capacity: All parties must have legal capacity to enter into the contract. This typically means: being of sound mind. not a minor (being over 18 years of age), not under duress, coercion, or undue influence. Legality: The contract must have a lawful purpose. Contracts that involve illegal activities (e.g., fraud, drug sales, unlicensed services) are void and unenforceable. While most contracts can be oral, certain types must be in writing to be enforceable under the Statute of Frauds, including: real estate contracts, contracts lasting more than one year, promises to pay someone else's debt, marriage-related agreements, sale of goods over a certain amount (e.g., $500 under the UCC). A written contract must be signed by the party to be charged. Certainty of Terms: The terms must be sufficiently clear for a court to enforce. Vague or indefinite agreements (e.g., “we'll figure out the price later”) may be unenforceable.

Transaction validation: is the authenticated act of attesting to the contents and terms of a transaction. This validation can be performed by a verified party whose digital identity has been confirmed using biometric authentication, geolocation, device ID, and token grading. Each transaction validation can be cryptographically logged on an immutable ledger, creating a verifiable, non-repudiable record of the participant's authorization and intent, and may include role-based organizational authority derived from validated resolutions tied to digital representations of individuals and organizations.

For transactions requiring execution on behalf of an organization, the system can verify the attestor's authority using an digital representation. Each officer, director, or shareholder is verified through biometric identity matching and is required to validate a resolution, executed as its own Pactvera, authorizing one or more individuals to act as representatives of the entity. This authorization is logged immutably and forms the basis for authority-based transaction validation. This process ensures traceability and non-repudiation of authority in enterprise environments and allows for real-time confirmation of authorization validity.

Unlike prior systems where organizational authority is assumed or relies on unenforceable attestations, the present invention introduces a verifiable organizational chain of authority. An authority resolution transaction (ARP) is executed by biometric-verified stakeholders and recorded immutably, defining which users may execute future transactions on the entity's behalf. This establishes a provable, time-specific delegation of power that is audit-friendly and non-repudiable. The ARP can be used to further increase the value of the Pactvera.

The memorialization of a transaction, including a Pactvera, is called a Valitorum can be the final immutable, and validated output of a transaction workflow of this system. It represents the complete, executed, and legally binding record of the transaction. Properties of a Valitorum include tokenized it as a non-fungible asset stored on an immutable ledger, authenticated via biometric and decentralized identity verification, bound to an originating party through digital ID, encapsulated with all transaction metadata including time, location, device ID, and token grade, and jurisdictional compliance, locked against further edits or changes and queryable as a cryptographic proof of origin, authority, and execution intent. Valitorum can serve as a litigation-ready, compliance-grade digital artifact enforceable under applicable law, and may include embedded value, conditional consideration, and recorder submission verification. A Valitorum may be independently validated for proof of authenticity, source, and compliance across jurisdictions.

A tokenized consideration asset (TCA) can be a subclass of a VDT representing the object of consideration in a transaction, which may include monetary value, title to a physical asset (e.g., vehicle, property), service rights, or access permissions. TCAs are transferred upon successful transaction validation and rule fulfillment.

The BRE is capable of enforcing condition sets defined by policy creators or transaction originators. Conditions may include temporal constraints, jurisdictional limits, age or authority of participants, and originality of the tokenized instance. If a required input is unverifiable (e.g., location spoofing, expired ID), the BRE flags the transaction as “validation incomplete,” preventing execution and triggering a compliance log event. If contested, a transaction token and its full metadata record are retrievable for third-party adjudication. The BRE can manage and enforce complex operational logic and decision-making processes associated with the transaction and its implementation. The BRE may be configured to interpret and execute predefined business rules that govern various aspects of the Pactvera management of the tasks and their flow in the Pactvera. In some implementations, the BRE may dynamically evaluate incoming data, user attributes, and system states to determine appropriate actions or responses.

The BRE may support the creation, modification, and deletion of rules through a user-friendly interface, allowing administrators to adapt the system's behavior without requiring extensive programming knowledge. Additionally, the BRE may integrate with other system components, such as the immutable storage system and verification modules, to ensure consistent application of policies across the entire platform consistent with a transaction and a Pactvera.

The system enables immutable, tokenized agreement workflows using biometric identity, decentralized authority validation, and programmable business logic. The system can include one or more capture devices adapted to receive biometric, alphanumeric, graphical, and environmental data from a participating party;

A verification engine in communication with the capture device, adapted to generate a digital representation of the party and validate identity against authoritative records through digital ID, either ChainIT ID for individuals or Org ID for organizations. A mechanism for creating a tokenized transaction represented as a NFT stored on an immutable ledger, encapsulating metadata such as authorship, timestamp, device ID, geolocation, jurisdiction, and token grade. The system can include an ARP module for confirming organizational authority via immutable, biometric-verified resolutions signed by officers or shareholders using the Org ID. A BRE enforces execution conditions (e.g., who must validate, where, when, and how), and triggers conditional consideration including monetary value or VDT representing physical goods, services, or access rights, upon satisfaction of these conditions and secure, interoperable storage and identity management protocols allowing selective disclosure, and compliance with legal and regulatory frameworks. This system provides a tamper-evident, audit-grade record of identity, authority, execution, and consideration for each transaction, ensuring long-term enforceability, verifiability, and regulatory defensibility in commercial, governmental, and contractual contexts.

Transaction validation differs from a traditional signature in that it requires biometric confirmation, location metadata, device identity, and token-grade verification—creating a chain of evidentiary attributes tied to a ChainIT ID. This validation framework exceeds legal requirements and security standards by demonstrating not only the identity and intent of the attestor, but also their contextual capacity (such as age, jurisdiction, device, authority) at the time of execution and meet many of the requirements of a valid enforceable contract. Unlike typical e-signatures, transaction validation creates a cryptographically sealed, real-time attestation event. Further it not only represents a transaction but also implements and effectuates the transaction by taking actions and preforming tasks described in the transaction.

The system can include individual digital identities using biometric authentication (e.g., facial recognition, fingerprint, voice), alphanumeric data, device ID, and validation against authoritative sources (e.g., Divisions of Motor Vehicles, Internal Revenue Services, States Departments etc.), establishes organizational identity and issues ARPs wherein these tokenized records confirm the authority of corporate officers or shareholders to act or attest on behalf of an entity, facilitates the creation of a Pactvera, represented as a NFT on an immutable ledger, captures metadata including creator identity, timestamp, geolocation, token grade, and device fingerprint.

Within this system, two distinct classes of tokenized assets can be used. A VDT that can be a non-fungible token that represents immutable proof of verification, inspection, or event capture (e.g., proof-of-view, notarization, geotagging, or asset status). The system can support the embedding of digital assets or rights (e.g., title to property, license to service) directly into the transaction and these VDTs can be transferred as actual consideration or conditional according to the BRE or terms of the transaction. There can be a TCA used to fulfill the legal requirement of consideration in a contract. TCAs can represent payment obligations, digital goods, real-world assets, or rights to services. Their issuance and transfer are conditional, programmable, and enforced via smart contract logic in the Transaction.

This dual-layer token model allows the system to both verify truth (such as with a VDTs) and effectuate contractual value exchange (such as with a TCAs), distinguishing it from traditional e-signature and blockchain metadata solutions.

The BRE can be configured to enforces logical rules for transaction execution and consideration distribution, based on programmable criteria such as geographic location, device identity, verified identity to an authority of truth to include age of validating parties, token originality and grade, and temporal alignment. The BRE within the transaction can provide functions such as a compliance arbiter and contract law interpreter. Rules are structured as programmable logic and may include: identity type requirements (e.g., ChainIT ID grade, token grade, biometric score, etc.), jurisdictional limitations (e.g., parties must be present in a proper legal territory), temporal validity (e.g., contract must be executed within 30 days of issuance), authority validation (e.g., ARP verification match), transaction sequencing (e.g., “payer must validate before provider can confirm”). A token grade may represent a measure of quality, authenticity, or value assigned to a digital token. In some aspects, the token grade may be determined based on various factors such as market capitalization, trading volume, developer activity, community engagement, technological innovation, and regulatory compliance. The grading system may utilize a numerical scale, letter grades, or descriptive categories to classify tokens. The grading process may involve both quantitative analysis of on-chain data and qualitative assessment of project fundamentals. Token grades may also consider factors such as token distribution, governance structure, and real-world adoption. In certain instances, token grades may be used as a risk assessment tool for authentication and validation or for regulatory compliance purposes.

Upon transaction validation initiation, the BRE can automatically evaluates whether conditions are met. If successful, the system can emit a “Valid Execution State,” which then triggers a smart contract module to finalize the transaction, transfer tokenized consideration (e.g., TCA or escrow funds), or generate a Valitorum, signifying immutable, verified contractual execution. If a condition fails (e.g., expired ID, unrecognized device, restricted region), the smart contract halts and logs a “Failed Execution State,” preventing further action and recording a rejection event on-chain. In this state the transaction, including a Pactvera, is not implemented or completed.

In the event of a system-level exception, data input anomaly, or execution failure, including, but not limited to, device malfunction, biometric mismatch, or network instability, the system can generate an immutable audit pending state. This record can require human review and secondary verification. A manual override may be initiated by authorized personnel through a logged administered interface, subject to internal policy, evidentiary standards, and rules governing admissibility in legal or regulatory forums.

The system can record every event associated with the transaction and Pactvera including creation, transaction validation, transfer, and resolution. to an immutable ledger.

In one embodiment, the system can provide regulatory compliance by using a real property submission interface. This feature can include jurisdictional metadata tagging, notarial equivalency via biometric presence, and state recorder integration. system provides mechanisms for the generation, submission, and permanent memorialization of real property documents. Each transaction is authenticated by biometric verification (e.g., facial recognition, liveness detection), embedded with metadata capturing who, when, where, and how it was validated;, recorded as a NFT containing a cryptographic hash of the original document, submitted to a state/county electronic recorder interface through a secure transmission layer such an as application programming interface (API), and automatically logged as a proof-of-record on an immutable ledger.

This system can meet the requirements of the Uniform Real Property Electronic Recording Act (URPERA) in several ways. By utilizing blockchain technology and digital validation, signatures (e.g., ChainIT ID), the system provides a secure and tamper-resistant method for recording and storing real property documents electronically. The use of biometric data and multi-factor authentication for identity verification can satisfy URPERA's requirements for ensuring the authenticity and integrity of electronic documents. The system's ability to capture and store metadata, including timestamps and location data, can fulfill URPERA's provisions for maintaining an audit trail of document submissions and modifications. Additionally, the distributed nature of the blockchain architecture aligns with URPERA's goals of promoting interoperability and standardization across different jurisdictions. The system's immutable storage capabilities address URPERA's requirements for long-term preservation and accessibility of electronic real property records. By incorporating these features, the system can provide a comprehensive solution that adheres to the principles and objectives of URPERA, potentially facilitating the adoption of electronic recording practices in real property transactions.

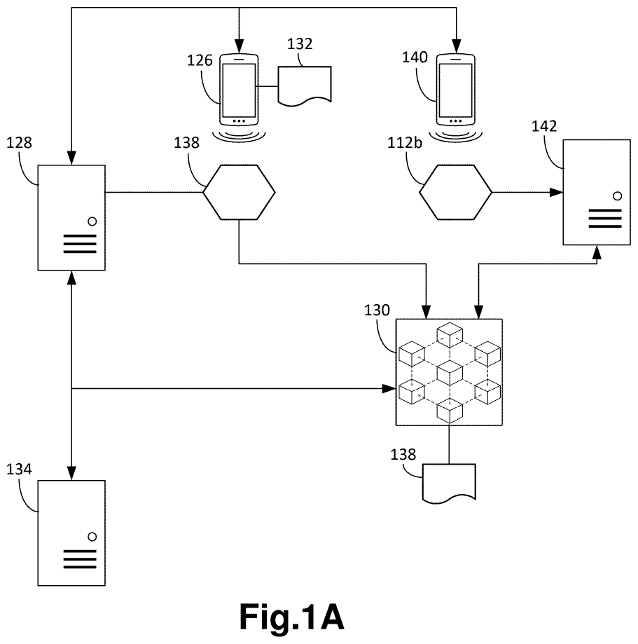

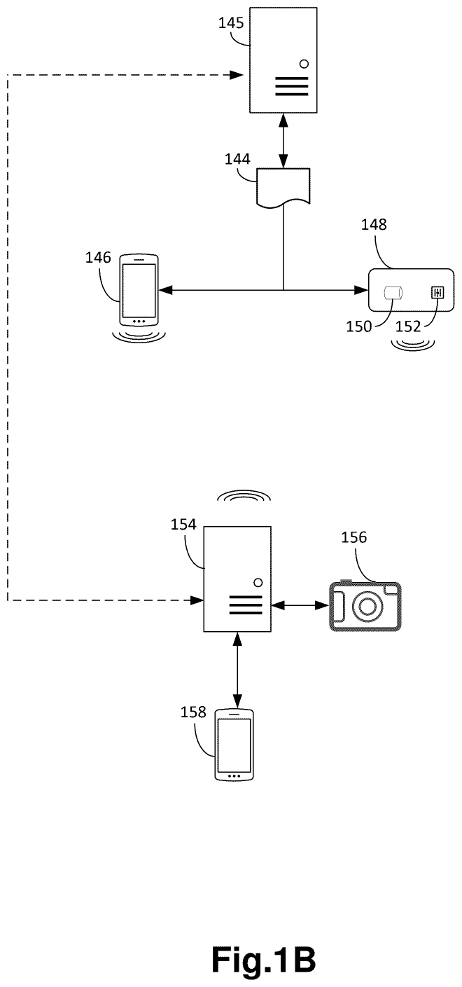

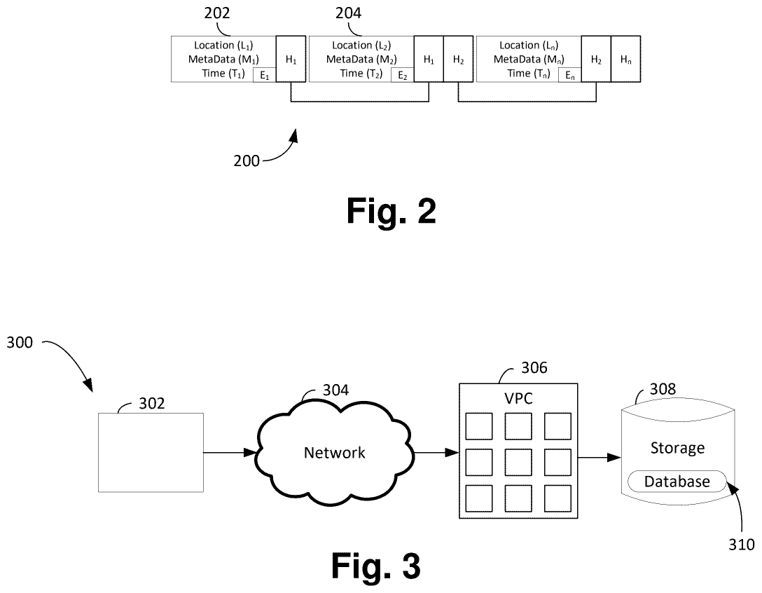

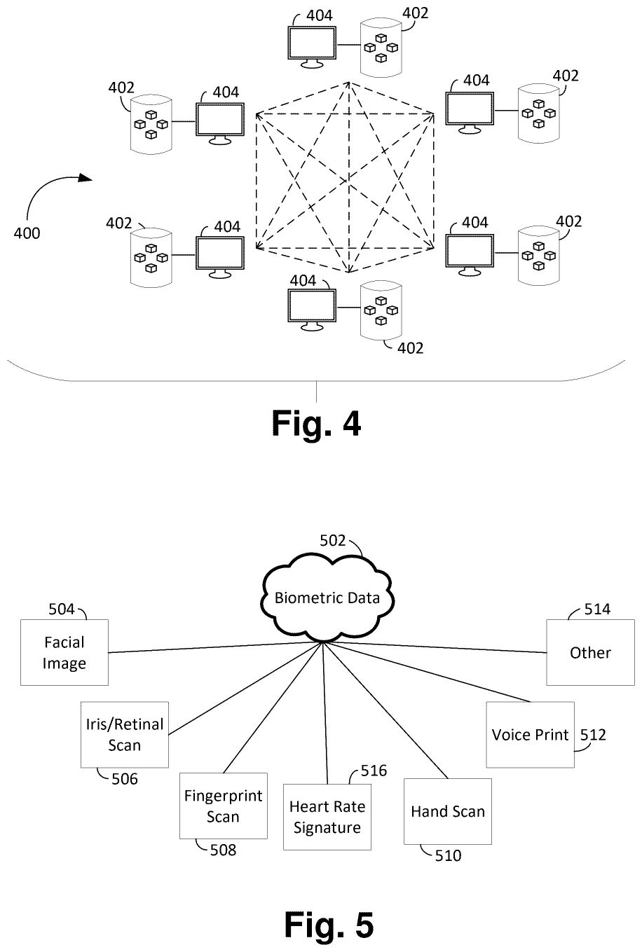

Referring to FIG. 1A, a digital document verification and authentication system used to create, record and otherwise memorialize and implement a transaction, a Pactvera, is shown. The system includes a first computing device, such as a mobile device, 126 in communication with a first server 128. The first server 128 connects to blockchain storage 130 and can transmit a first message 132 to a second server 134. The first server 128 can also transmit a second message 138 to the blockchain storage 130. A second mobile device 140 communicates with a third server 142 through a network connector 112b. The third server 142 can access the blockchain storage 130 to retrieve stored verification data.

The system enables communication between computing devices and servers through various network connections. The first computing device 126 can capture and transmit document information to the first server 128, which processes and stores verification data on the blockchain storage 130. The second computing device 140 can request verification through the third server 142, which retrieves the stored blockchain data for authentication purposes.

In one example, the system can retrieve a digital identity record, ChainIT ID, stored in the blockchain storage 130. In one configuration, ChainIT ID can be an alpha-numeric code, graphical image, bar code, or digital quick response (QR) code that can be displayed on the first mobile device 126 or second mobile device 140. This allows for easy presentation and use of the ChainIT ID. When presented to an appropriate reader connected to the first server 128 or third server 142, the ChainIT ID can be retrieval from the blockchain storage 130.

The network connector 112b facilitates data transfer between the second mobile device 140 and the third server 142. The first message 132 and second message 138 contain document verification and authentication data that flows between the system components, enabling secure and efficient identity verification processes.

Referring to FIG. 1B, a system is shown. The system can include a verification server 145 that stores a digital representation 144. The ChainIT ID 144 can be stored on a mobile device 146 or an identification card 148. The identification card 148 includes storage media 150 and an EMV chip 152. In one example, the ChainIT ID 144 can be stored in an encrypted format, such as a hash. Various hashing methods can be used, including a-hash (average hashing), p-hash (perceptual hashing), d-hash (difference hashing), or w-hash (wavelet hashing). These hashing methods provide secure and efficient ways to store and compare digital identity information.

A transaction system 154 can receive information from the identification card 148. The transaction system 154 can retrieve the encrypted digital representation from the identification card 148 and compare it with information received from other sources to verify identity. A capture device 156 connects to the transaction system 154 and captures presenter information. In one configuration, the capture device 156 can be a camera or biometric scanner that obtains real-time data from an individual presenting the identification card 148. The system allows a presenter device 158 to communicate with the transaction system 154. In some cases, the presenter device 158 can be a smartphone or other mobile device that the individual uses to provide additional authentication factors.

The components are interconnected through communication pathways shown by the arrows in the diagram, enabling data flow between the verification server 145, mobile device 146, identification card 148, transaction system 154, capture device 156, and presenter device 158 for identity verification purposes.

In one embodiment, when an individual presents the identification card 148 for verification, the transaction system 154 can retrieve the encrypted digital representation from the card's storage media 150 or EMV chip 152. The capture device 156 can simultaneously obtain current biometric or image data from the individual. The transaction system 154 can then compare the retrieved encrypted representation with a hash of the newly captured data to determine if there is a match, thereby verifying the individual's identity without exposing the original personal information.

The system can include a metadata sequence 200 that incorporates interconnected metadata blocks. The metadata sequence 200 includes location metadata blocks 202 and time metadata blocks 204 arranged in a linear configuration. The location metadata blocks 202 and time metadata blocks 204 are connected by linking elements, allowing for the association of spatial and temporal data within the sequence.

In one example, the location metadata blocks 202 can contain geographical coordinates, address information, or other location-specific data. The time metadata blocks 204 can include timestamps, date information, or duration data. By linking these blocks, the metadata sequence 200 creates a comprehensive record of when and where specific events or actions occurred within the system.

The system also includes a network system 300 that facilitates data flow and component relationships. A client device 302 connects to the network system 300 through a network cloud 304. The network cloud 304 serves as an interface between the client device 302 and the system resources.

In one configuration, the network cloud 304 connects to a virtual private cloud (VPC) 306. The VPC 306 contains multiple compartmentalized units, providing secure and isolated environments for data processing and storage. Beyond the VPC 306, the network system 300 connects to a storage system 308.

The storage system 308 includes database storage 310, which can store various types of data, including the metadata sequence 200. The database storage 310 can be used to maintain records of transactions, user information, and other relevant data for the digital identity verification system.

In one embodiment, data flows linearly through the network system 300, starting from the client device 302. The data passes through the network cloud 304 and VPC 306 before reaching the storage system 308 with its database storage 310. This sequential arrangement ensures secure and efficient data transmission throughout the system.

The network system 300 can integrate with other components of the digital identity verification system. For example, the client device 302 can be the first mobile device 126 or the second mobile device 140, initiating identity verification requests. The VPC 306 can host the first server 128, second server 134, or third server 142, processing these requests and interacting with the blockchain storage 130.

In some cases, the storage system 308 and database storage 310 can work in conjunction with the blockchain storage 130 to provide a hybrid storage solution. This approach combines the immutability and distributed nature of blockchain with the query efficiency of traditional database systems.

The metadata sequence 200 stored within the database storage 310 can be used to enhance the functionality of the digital representation 144. By associating location and time data with identity verification events, the system can provide additional context and security for authentication processes.

The network system 400 includes a distributed configuration of storage nodes 402 and client terminals 404. The storage nodes 402 are interconnected with corresponding client terminals 404 through communication pathways, forming a mesh-like topology. This configuration allows for efficient data communication between any storage node 402 and client terminal 404 pair within the network system 400.

In one example, the storage nodes 402 can contain data storage capabilities, enabling distributed storage of digital identity information and associated metadata. The client terminals 404 provide user interface points for accessing and interacting with the network system 400, allowing users to initiate identity verification requests or retrieve stored information.

The network system 400 incorporates a biometric data cloud 502 containing multiple specialized modules for processing different types of biometric information. These modules enhance the capabilities of the capture device 156 by providing advanced biometric processing functionalities.

In one configuration, the biometric data cloud 502 includes a facial image module 504 for analyzing facial features and generating digital representations based on captured images. An iris retinal module 506 processes eye-based biometric data, while a fingerprint module 508 handles fingerprint analysis and matching. The system also incorporates a hand scan module 510 for processing hand geometry and vein patterns.

The biometric data cloud 502 further includes a voice print module 512 for analyzing and authenticating vocal characteristics. A heart rate module 516 can process cardiac rhythm data as an additional biometric identifier. An auxiliary module 514 is also included to provide flexibility for integrating additional biometric processing capabilities or supporting functions as needed.

In one embodiment, the biometric data cloud 502 can interface with the distributed network structure formed by the storage nodes 402 and client terminals 404. This integration enables biometric data processing and storage capabilities throughout the system, enhancing the overall functionality of the digital identity verification process.

The capture device 156 can include two-factor authentication prior to allowing the verification process to occur. In one example, this two-factor authentication can combine biometric data processed by one of the specialized modules in the biometric data cloud 502 with additional verification factors. These factors can include a password, a one-time code sent to the mobile device 146, or a digital token stored on the identification card 148.

By incorporating two-factor authentication, the system enhances security and reduces the risk of unauthorized access or fraudulent identity verification attempts. This multi-layered approach ensures that even if one authentication factor is compromised, the overall integrity of the verification process remains intact.

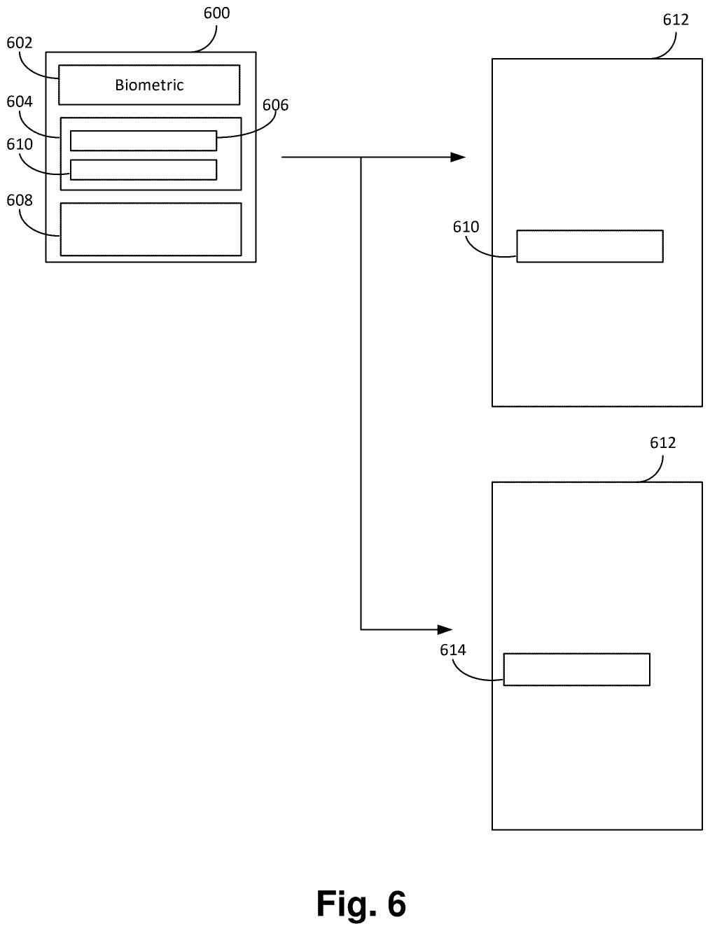

Referring to FIG. 6, a method 600 for selective data authentication is illustrated. The method 600 begins at a step 602, where a biometric input 604 and other input fields 606 are received. The biometric input 604 can include data captured by the capture device 156, such as facial images, fingerprints, or other biometric identifiers processed by the biometric data cloud 502. The other input fields 606 can contain various types of data that can be authenticated, such as personal information or transaction details.

From these inputs, selected data 610 is identified for authentication. In one example, the selected data 610 can include specific attributes from the digital representation 144 stored on the identification card 148 or in the blockchain storage 130. The selection process allows for privacy-preserving verification by limiting the amount of personal information exposed during authentication.

The selected data 610 is then provided to an authentication system 612. In one configuration, the authentication system 612 can be part of the transaction system 154 or can be implemented within the server cluster 606. The authentication system 612 processes the selected data 610 by comparing it against stored verified information, which can be retrieved from the blockchain storage 130 or the database storage 310.

In one embodiment, the authentication system 612 can utilize the specialized modules within the biometric data cloud 502 to process and compare biometric inputs. For example, if the selected data 610 includes facial recognition information, the facial image module 504 can be employed to analyze and match the data against stored records.

The authentication system 612 generates a binary response 614 indicating whether the authentication was successful or unsuccessful. This binary response 614 provides a clear and unambiguous result of the authentication process without revealing additional personal information.

The method 600 enables selective authentication where specific portions of input data can be chosen for verification while maintaining privacy of other data elements. This approach allows for flexible and context-specific identity verification, adapting to different security requirements and privacy concerns across various use cases.

In one example, the method 600 can be initiated when a user presents a ChainIT ID to the capture device 156 at a point of transaction. The capture device 156 obtains the biometric input 604, while the transaction system 154 retrieves relevant information from the ChainIT ID to populate the other input fields 606. The user or the system can then select which data elements to include in the selected data 610 for authentication. The authentication system 612 processes the selected data 610 and compares it against the digital representation 144 stored in the blockchain storage 130. Based on this comparison, the authentication system 612 generates the binary response 614, which can be used by the transaction system 154 to approve or deny the transaction.

In another configuration, the method 600 can be applied in a remote authentication scenario using the network system 300. The client device 302 can capture the biometric input 604 and transmit it through the network cloud 304 to the virtual private cloud 306. The authentication system 612, hosted within the VPC 306, can then process the data and return the binary response 614 to the client device 302, enabling secure remote identity verification.

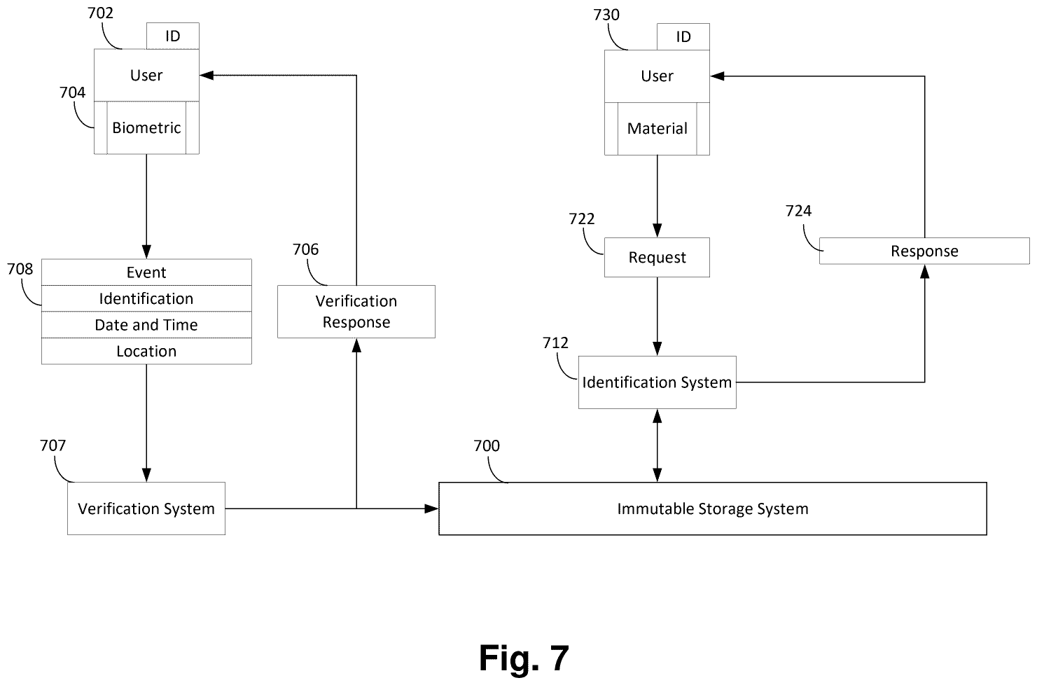

Referring to FIG. 7, a digital identity verification process is illustrated. The process involves interactions between multiple components for processing transactions and creating, recording and implementing Pactveras. The process can begin with a user 702 providing biometric information 704 to a verification system 707. The biometric information 704 can include data captured by the capture device 156, such as facial images processed by the facial image module 504 or fingerprints analyzed by the fingerprint module 508. The verification system 707 processes this information and generates a verification response 706.

In one example, the verification system 707 can compare the received biometric information 704 against stored digital representations 144 to authenticate the user's identity. The verification response 706 can indicate whether the authentication was successful or if additional verification steps are required.

An transaction 708 is created containing identification information, date and time details, location data, transaction data, conditions and the like. This transaction 708 can be similar to the metadata sequence 200, incorporating location metadata blocks 202 and time metadata blocks 204 to provide a comprehensive record of the verification process.

The verification system 707 communicates with an immutable storage system 700, which serves as a secure repository for verified transaction. The immutable storage system 700 can be implemented using blockchain technology, similar to the blockchain storage 130, ensuring that stored records cannot be altered or tampered with.

A separate user 730 can initiate a request 722 that is sent to the identification system 712. This user 730 can interact with the system through a client device 302 or mobile device 146. The request 722 can be for various purposes, such as accessing a secure service or authorizing a transaction.

The process can incorporate multiple verification steps and secure storage of transaction information through the immutable storage system 700. This approach enhances the reliability and trustworthiness of the Pactvera, as each verification event is recorded and can be audited if necessary.

In some cases, the verification system 707 and identification system 712 can work in conjunction with the biometric data cloud 502 to process complex biometric inputs. For example, if the user 702 provides a voice sample as part of the biometric information 704, the voice print module 512 can be utilized to analyze and authenticate the vocal characteristics. The digital identity verification process demonstrates how the various components of the system interact to provide secure, efficient, and privacy-preserving identity verification. By leveraging biometric data, immutable storage, and specialized processing systems, the process ensures robust authentication while maintaining user control over personal information.

The system can use smart contracts for implementing business logic rules such as those used by the BRE. Smart contracts can be deployed on the blockchain storage to automate and enforce specific acts and conditions in the transaction. For instance, a smart contract can define conditions under which certain digital representations are considered valid for authentication purposes. In one configuration, the smart contract can interact with the verification system to determine if a user meets predefined criteria before implementing the Pactvera. This can include checking the user's role, verifying their location through the metadata sequence, or confirming the validity of their digital representation.

The transaction system can interface with these smart contracts to execute identity-dependent transactions. When a user initiates a transaction, the smart contract can use the ChainIT ID, check compliance with business rules, and authorize or deny the transaction accordingly. In some cases, the smart contracts can also govern the creation and management of digital representations. The implementation of smart contracts within the system enhances security and automation. By encoding business logic directly into the blockchain, the system can implement and enforce transaction and their rules consistent across all interactions, reducing the risk of unauthorized activity or fraudulent activities.

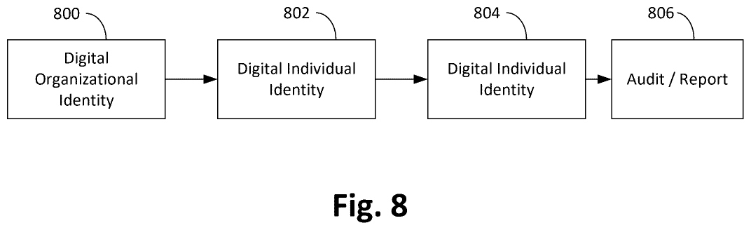

Referring to FIG. 8, the process of obtaining a digital identity for an individual or organization is shown. The process can being at step 800 where the individual applies for a receives an organizational digital identity (e.g., OrgID). The individual can also sign up for and receive a individual digital identify (e.g., ChainIT ID) at 802.

At 804 the approval and creation process for individual and organizational and individual digital identities can include the person submitting an application through a secure online portal or at a designated physical location. The application may include basic personal information, contact details, and supporting documentation to verify identity. Once submitted, the application may be reviewed by trained personnel who verify the provided information against existing databases and records. This verification process may involve cross-referencing multiple sources to ensure accuracy and authenticity of the submitted data. In some cases, the individual may be required to provide biometric data, such as fingerprints, facial scans, or iris scans. This biometric information may be captured using specialized equipment at authorized collection points. The collected biometric data may then be digitized and securely stored for future reference and verification purposes.

The applicant may also undergo a background check, which may include reviewing criminal records, financial history, and other relevant databases. This step may help ensure the integrity of the ChainIT ID system and prevent potential misuse. Once all necessary information has been collected and verified, a review committee or automated system may evaluate the application based on predetermined criteria. If approved, the individual may be notified and provided with instructions on how to activate and use their ChainIT ID. In some implementations, the approved individual may be required to attend an in-person appointment to finalize the process, where they may receive additional instructions, have their photo taken, or complete any remaining verification steps. The ChainIT ID may then be issued in a secure digital format, potentially accessible through a mobile application or secure online portal. In some cases, a physical card or token may also be provided as a backup or alternative means of identification. To maintain the validity of the ChainIT ID, periodic reviews or renewals may be required. This process may involve updating personal information, re-verifying certain data points, or providing additional documentation as needed to ensure the continued accuracy and security of the identification system. The same or similar process can be used for organizational digital identities and to associate a ChainIT ID with an organization as an approved representative. Auditing and report of the process can be provided at 806.

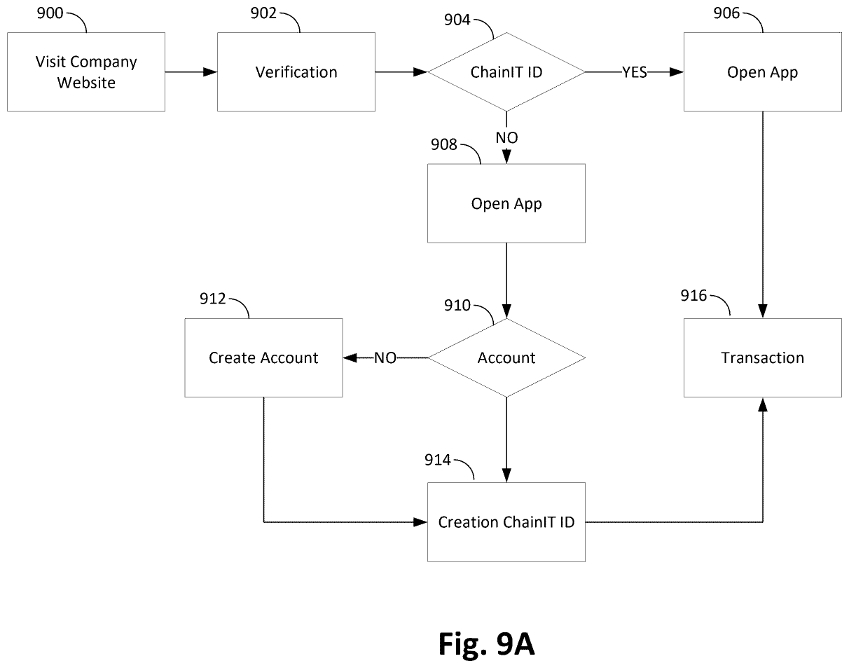

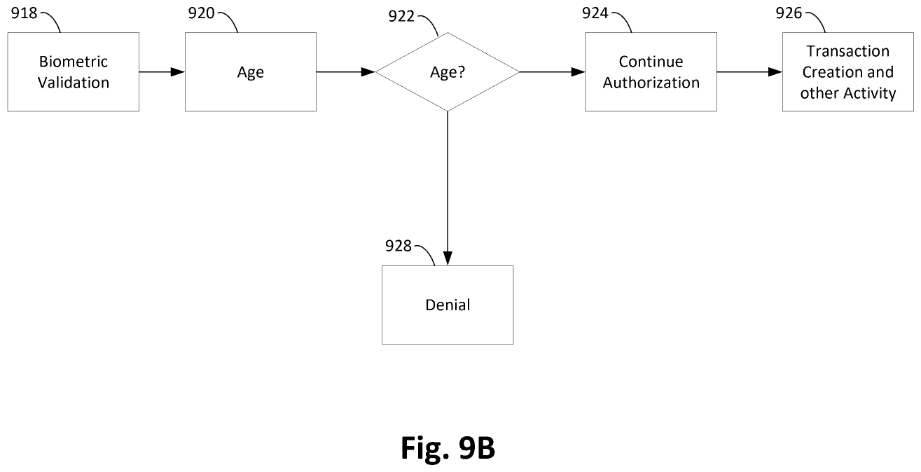

Referring to FIG. 9A, a process of the system is illustrated. The process begins at a step 900 where a user visits a company website to initiate a transaction. The process then moves to a step 902, where the user is verified such as with their mobile device camera to determine if they are allowed to create a transaction. This can be done using a ChainIT ID. At a step 904, the process determines if a ChainIT ID exists. If the ID exists, the process proceeds to a step 906 which may open the ChainIT app where a verification permission modal is acknowledged. If the app is not installed, the process moves to a step 908, where the app store is opened. At a step 910, the process checks if the user has an account. If no account exists, the process proceeds to a step 912 to create an account and to 914 to creates a ChainIT ID. If an account exists, or after creating a new account, the process moves to a step 916 for the creation of a transaction.

Referring to FIG. 9B, certain transactions require certain authorizations such a minimum age. The process can being with biometric validation at 918, where the user's biometric data is validated. The biometric validation 918 can utilize the capture device to obtain biometric input from the user. In one example, the facial image module of the biometric data cloud can process facial recognition data to verify the user's identity. Following validation, the process can move to an age verification service 920, which checks age and logs the transaction. The age verification service 920 can interact with the blockchain storage to retrieve and verify the user's age information stored in their digital representation. The process then proceeds to a user age decision 922, where the system evaluates if the user meets the required age criteria. If the user meets the age requirement, the process advances to an authentication continuation 924, followed by transaction creation and other activity 926.

If the user does not meet the age requirement, the process moves to a user denial 928. In one configuration, the user denial 1016 can trigger a notification to the user's mobile device, informing them of the restriction. The process includes a transaction log 1015, which records no personally identifiable information (PII), hash, pass/fail status, location (state), and date/time information. The transaction log 1015 can be stored in the immutable storage system, ensuring a secure and tamper-proof record of the verification process. In one example, the transaction system can interface with smart contracts deployed on the blockchain storage to enforce age verification policies. These smart contracts can define the conditions under which a user's age is considered verified and automatically grant or deny access based on the verification results.

The user verification process for age-restricted websites integrates multiple components of the digital identity system, including biometric validation, blockchain-based data storage, and smart contract enforcement. This approach ensures robust age verification while maintaining user privacy and data security.

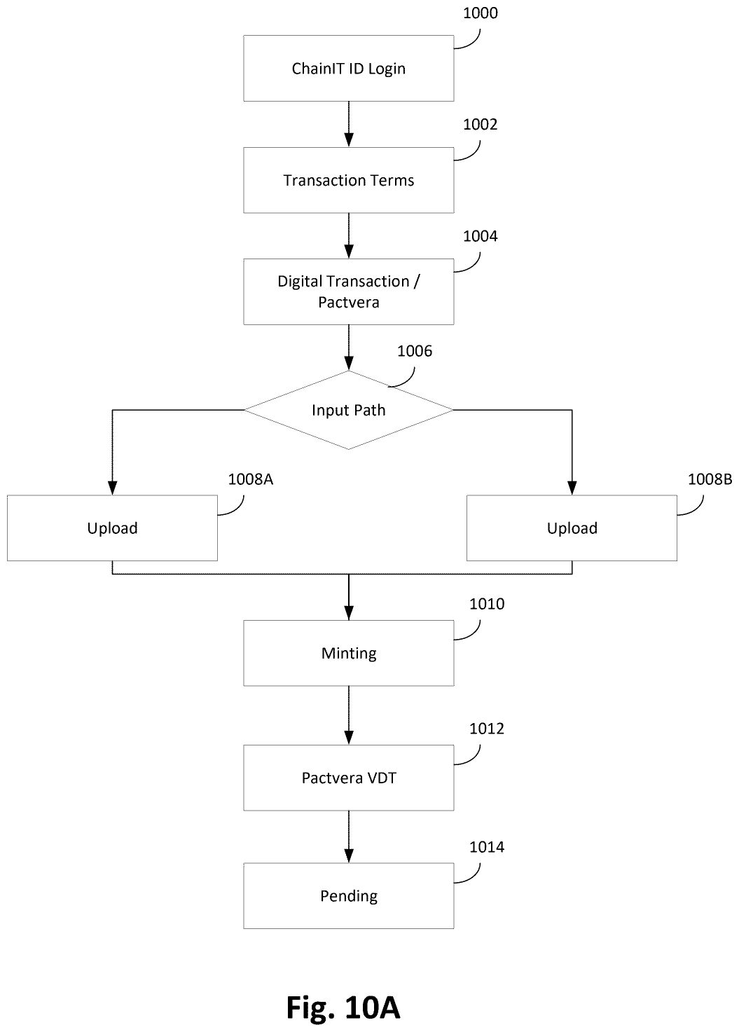

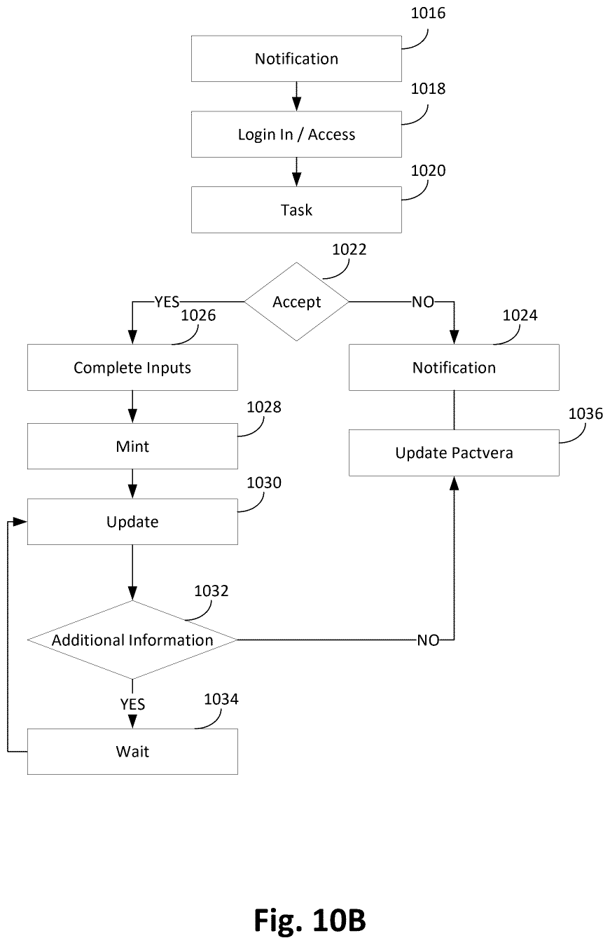

FIG. 10A illustrates a flowchart depicting the Pactvera instantiation process. The process may begin with a user performing a biometric multi-factor authentication (MFA) login to ChainIT systems 1000. This authentication step may enhance security and verify the user's identity before proceeding with the Pactvera creation. Following successful authentication, the user may select transaction terms at 1102 used for the transaction terms including participants, conditions, consideration, triggers, etc. of a Pactvera. This selection step may allow users to choose from various predefined templates or configurations tailored to specific use cases, products, goods, industries, transactions and the like. The process may then proceed to the creation of a Pactvera at 1004. During this step, users may input initial information or customize the Pactvera according to their requirements. After creation, a decision point at 1006 where, in one embodiment, the user may choose between two configuration paths: Upload or Inputs. This branching allows for flexibility in document handling and data input methods. If the Upload path is selected, the process may move to step 1008A, where documentation is attached. This option may be useful for users who have existing documents they wish to incorporate into the Pactvera. Alternatively, if the Inputs path is chosen, the process may proceed to step 1008B, where user inputs and validation, signature, templates are configured. This path may allow for more granular control over the data and structure of the Pactvera. Both configuration paths converge at step 1010, where transaction and document VDTs are minted. VDTs may serve as digital representations of the physical or conceptual entities involved in the Pactvera. The process may then combine these VDTs into a Pactvera VDT at 1012. This combination step may create a comprehensive digital representation of the entire Pactvera, including all associated documents and transactions. The process can then enter a pending state at 1014, where it waits for validation, signatures. This state may indicate that the Pactvera is ready for review and approval by relevant parties. Throughout this process, the system may leverage blockchain or distributed ledger technology to ensure the integrity and immutability of the created Pactvera and its associated VDTs. The use of biometric MFA and digital validation, signatures may enhance security and provide a robust audit trail for the Pactvera instantiation process.

FIG. 10B illustrates a flowchart depicting the Pactvera execution process. The process may begin with receiving a request notification at 1016, which may alert the user to an action or task that requires their attention. Following this notification, the user may perform a biometric multi-factor authentication (MFA) login to the ChainIT ID application at 1018. This authentication step may help ensure the security and integrity of the process by verifying the user's identity. After successful authentication, the user may open the task associated with the request at 1020. At this point, the flowchart presents a decision point where the user may choose to either accept or reject the task. If the user decides to reject the task, the process may send a notification to the sender at 1024, potentially informing them of the rejection and allowing for further action or communication.

If the user accepts the task, the process may proceed to the completion of inputs and validation, signatures at 1026. During this step, the user may provide necessary information, make required selections, or digitally sign documents as specified by the task requirements. Following the completion of inputs and validation, signatures, the process may move to minting a data VDT 1028 and updating the Pactvera at 1030. This step may create a digital representation of the task-related data and integrate it into the existing Pactvera structure.

The decision point to determine if additional information or activity at 1032 can include if validation, signatures or other information or tasks are needed. If more validation, signatures are required, the process may enter a waiting state at 1034 for validation, signatures before returning to update the Pactvera. This loop may allow for multiple parties to review and sign off on the task or document as necessary. If no additional validation, signatures are needed, the process may conclude by updating the transactional VDT and transferring value at 1036. This final step may involve recording the completed transaction on the blockchain or distributed ledger, ensuring its immutability and traceability. The transfer of value may represent the execution of a smart contract, the exchange of digital assets, or the completion of a predefined transaction associated with the Pactvera. Throughout the Pactvera execution process, the system may utilize blockchain technology to maintain a secure and transparent record of all actions and decisions. The use of VDTs may provide a comprehensive digital representation of the entire process, from task initiation to completion. This approach may enhance the efficiency, security, and auditability of complex transactions or agreements executed through the Pactvera system.

In one embodiment, the Pactvera instantiation process can include the identity recording system receiving biometric information from the capture device during the biometric MFA login step. The identity recording system may then process this information to authenticate the user before allowing access to the ChainIT systems. The system may be in communications with the immutable storage system. During the Pactvera execution process, the identity recording system may be involved in the biometric multi factor authentication login step using ChainIT ID and its application. The identity recording system may verify the biometric information received against stored identity records to ensure secure access to the system. The identity recording system may be implemented in various configurations. In some cases, the identity recording system may be centralized, where all identity information is processed and stored in a single location. In other cases, the identity recording system may be decentralized, with processing and storage distributed across multiple nodes.

The identity recording system may also be designed to be immutable, ensuring that once identity information is recorded, it cannot be altered or deleted. This may provide a high level of security and trust in the stored identity data. In some implementations, the identity recording system may be distributed across multiple locations or servers, enhancing reliability and accessibility. Alternatively, the identity recording system may be local, operating within a specific organization or network.

The identity recording system may be configured as a remote system, allowing access from various locations, or as a private system with restricted access. In some cases, the identity recording system may be shared among multiple organizations or users, while in others, it may be a private system dedicated to a single entity. Virtual implementations of the identity recording system may also be possible, where the system operates in a cloud-based environment. In some cases, the identity recording system may combine multiple characteristics, such as being both distributed and immutable, or both remote and private, depending on the specific requirements of the implementation.

In some cases, an immutable storage system may be used to maintain the integrity of digital transaction. The immutable storage system may be configured to store data in a manner that prevents modification or deletion once the data has been written. This characteristic may help ensure the authenticity and reliability of stored information. The immutable storage system may utilize various technologies to achieve immutability. In some cases, the immutable storage system may employ blockchain technology, which creates a chain of cryptographically linked blocks containing transaction data such as Pactvera data. Alternatively, the immutable storage system may use crypto-shredding techniques, where encryption keys are destroyed after data is encrypted, making the data effectively immutable.

In other implementations, the immutable storage system may utilize Write Once Read Many (WORM) storage, which allows data to be written only once but read multiple times. The immutable storage system may also employ append-only data structures, where new information can only be added to the end of existing data, preventing modifications to previously stored information. Distributed ledger technology may be used in some cases, where multiple copies of the data are maintained across a network of computers, making unauthorized alterations difficult. The immutable storage system 1130 may also leverage immutable cloud storage solutions or immutable record retention systems provided by cloud service providers.

In some implementations, the immutable storage system may incorporate quantum technologies to enhance security and immutability. Quantum key distribution or quantum encryption techniques may be employed to secure the stored data against potential future attacks by quantum computers. The immutable storage system may play a crucial role in both the instantiation and execution processes of a Pactvera. During the Pactvera instantiation process, the immutable storage system may be used to store the minted transaction VDT, document VDT, and the combined Pactvera VDT. This storage ensures that the created Pactveras remain tamper-proof and verifiable.

In the Pactvera execution process, the immutable storage system may be involved in storing and updating the Pactvera or associated VDT. The system may record each step of the execution process, from the initial acceptance to the final completion, creating an auditable trail of the Pactvera's lifecycle.

The immutable nature of the storage system may allow for the creation of a trusted record of all transactions and modifications related to a Pactvera. This feature may be particularly useful in scenarios where multiple parties are involved, as the immutable storage system can provide a single source of truth that all participants can rely upon.

In some cases, the immutable storage system may interact with other components of the Pactvera system. For example, the system may receive data from the identity recording system or the transaction server, ensuring that all relevant information is securely stored and remains unaltered over time. The use of an immutable storage system may enhance the overall security and reliability of the Pactvera. By preventing unauthorized modifications and maintaining a verifiable record of all transactions, the system may help build trust among participants and reduce the potential for disputes.

In some, the system may include an identification document. The identification document may be a physical or digital document. During the Pactvera instantiation process, the identification document may be processed as part of the “Attach Documentation” step. The capture device may scan or capture an image of the identification document. The identity recording system may then extract relevant information from the captured identification document to populate fields in the digital record. The identification document may play a role in the “Biometric MFA Login” step. The capture device may compare biometric data provided by the user against information stored in or derived from the identification document to enhance the multi-factor authentication (MFA) process. The verification system may use data from the identification document to cross-reference and validate the information provided during the instantiation or execution processes. In some cases, the verification system may access external databases to confirm the authenticity of the identification document.

The immutable storage system may store a secure hash or encrypted version of the identification document as part of the digital identity record. This allows for future verification without exposing sensitive personal information. In some implementations, the ChainIT ID may include a reference to the identification document, enabling quick retrieval and verification during subsequent transactions or authentications. The transaction server may use information derived from the identification document to enforce access controls or permissions based on the verified identity of the user during both instantiation and execution processes.

The system may include a verification system that can be adapted for authenticating users and validating information within the Pactvera process. In some cases, the verification system may interact with other components of the system to ensure the security and integrity of transactions. The verification system may be involved in the biometric MFA login step. The verification system may authenticate users by comparing the provided biometric data against stored records. In some implementations, the verification system may utilize multiple factors for authentication, potentially including fingerprints, facial recognition, or other biometric identifiers.

During the Pactvera element selection and creation steps, the verification system may validate user permissions and access rights. This may help ensure that only authorized users can create or modify Pactveras within the system. The verification system may be active throughout the process. When a request notification is received, the verification system may authenticate the user through the biometric MFA login to the ChainIT ID application. This authentication step may help prevent unauthorized access to sensitive information or transaction capabilities.

As the process moves through various stages such as opening tasks, accepting requests, and completing inputs and validation, signatures, the verification system may continuously validate user actions and permissions. This ongoing verification may help maintain the integrity of the digital accord process. During the minting of VDTs and updating of Pactvera steps, the verification system may work in conjunction with other system components to ensure the authenticity and integrity of the data being processed. The verification system may validate the source and content of information before it is minted into a VDT or used to update existing VDTs. In some implementations, the verification system may also play a role in the value transfer process. When updating the transactional VDT and transferring value, the verification system may verify the legitimacy of the transaction and the authorization of the parties involved. The verification system may utilize cryptographic techniques to ensure the integrity of data throughout the Pactvera process. This may include generating and verifying digital validation, signatures, hashing data to detect any unauthorized modifications, and encrypting sensitive information to protect it from unauthorized access.

In some cases, the verification system may maintain audit logs of all verification activities. These logs may be used for compliance purposes, troubleshooting, or detecting any potential security breaches or unauthorized access attempts. The verification system may also interface with external systems or databases to cross-reference and validate certain types of information. This may include checking professional licenses, verify company registrations, or confirm other relevant credentials that may be required for specific types of Pactveras. By continuously authenticating users and validating information throughout the Pactvera process, the verification system may help maintain the trustworthiness and legal validity of the transactions conducted within the system.

The system may include a ChainIT ID that represents and provides access to digital identity information. The digital identity record may contain various pieces of information associated with an individual's identity. This information may include biometric data, personal details, credentials, and other identity-related information. The digital identity record may be created by the identity recording system during an initial identity verification process. In some cases, the identity recording system may receive biometric information and identification data from a capture device, verify this information with a verification system, and then generate the digital identity record based on the verified information. In some cases, the identity recording system may receive biometric information and identification data from a capture device, verify this information with a verification system, and then generate the digital identity record 1136 based on the verified information.

During the Pactvera instantiation process, the ChainIT ID may be used to authenticate the user initiating the process. The biometric MFA login step may involve presenting the ChainIT ID along with biometric data to access the ChainIT systems. The ChainIT ID may again be utilized during the biometric MFA login step to access the ChainIT ID application. The digital identity record associated with the presented ChainIT ID may be retrieved and used to verify the user's identity and permissions for executing the Pactvera. The digital identity record may be maintained and updated over time by the identity recording system. Updates may include new credentials, changes in personal information, or additional biometric data. These updates may be reflected in the ChainIT ID, ensuring that it always provides access to the most current identity information.

In some cases, a transaction server may be included in the system for processing and managing digital transactions including Pactveras. The transaction server may interact with other components of the system to facilitate both the instantiation and validation, or execution, of Pactvera. During the Pactvera instantiation process, the transaction server may be involved in various steps. The transaction server may receive and process requests related to creating a new Pactvera, configuring user inputs and validation, signature, templates, and setting up value transfer smart contracts. The transaction server may play a central role in managing the flow of transactions. The transaction server may receive request notifications, process biometric multi-factor authentication logins, and handle task assignments. The transaction server may interact with the immutable storage system to store and retrieve Pactvera-related data. In some cases, the transaction server may be responsible for minting and updating VDTs associated with transactions and documents.

The transaction server may also communicate with the identity recording system and verification system to authenticate users and verify digital identities. In some cases, the transaction server may retrieve a digital identity record using a digital envoy and determine if the digital identity is authentic. This authentication process may involve comparing biometric information provided during a transaction with the stored digital identity record. During the validation, or execution, of a Pactvera, the transaction server may manage the validation, signing, process, including determining if additional validations, signatures, are needed and coordinating the transfer of value upon completion of all required validations. The transaction server may update the status of VDTs as transactions progress, marking them as complete with a Valitorum designation when all requirements have been met.

In some cases, the transaction server may handle notifications, such as sending alerts to senders when a task is not accepted or notifying relevant parties when validation, signatures, are pending. The transaction server may also manage the waiting periods for validation, signature, completions and coordinate the final updates to transactional VDTs upon successful execution of a Pactvera.

The Pactvera instantiation process may begin with a biometric MFA login to ChainIT ID systems. In some cases, the biometric MFA login may involve capturing biometric data such as fingerprints, facial features, or iris scans. The capture device for obtaining biometric data may be contained in a housing such as a kiosk and may be physically associated with a location. Following successful authentication, the process may move to a Pactvera product line selection step. Users may choose from various Pactvera product options available within the system. After product selection, the process may flow to a create Pactvera step, which may branch into multiple parallel paths. One path may lead to attaching PDF documentation. This step may allow users to upload and associate relevant documents with the Pactvera instance. Another path may involve configuring user inputs and validation, signature, templates. Users may define the required input fields and customize validation, signature, layouts for the Pactvera document. A third path may allow configuring a custom form. This step may enable users to design and structure the Pactvera document according to specific requirements. A fourth path may enable configuring value transfer smart contracts. Users may set up the terms and conditions for automated value transfers associated with the Pactvera instance.

The process may then move to minting transaction and VDT steps. This may include minting both a transaction VDT and a document VDT. The transaction VDT may represent the overall Pactvera transaction, while the document VDT may be associated with the attached documentation. These VDTs may then be combined into a mint Pactvera VDT. This step may create a comprehensive VDT that encapsulates all aspects of the Pactvera instance. The last can be the process waiting for validation, signatures, represented by a pending state. This step may indicate that the Pactvera instance is ready for execution and awaiting necessary validation, signatures, from relevant parties. In some cases, the entire Pactvera instantiation process may be conducted through a kiosk-based system, providing a secure and controlled environment for creating and initializing Pactvera instances.

The Pactvera execution process may begin when a request notification is received. Upon receipt of the notification, a biometric MFA login may be performed to access a ChainIT ID application. Once logged in, the process may move to opening a task associated with the request. The user may then evaluate whether to accept or reject the task. If the task is not accepted, a notification may be sent to the sender of the request. In some cases, this notification may include a reason for rejection or a request for additional information. If the task is accepted, the process may continue to the completion of inputs and validations, signatures. This step may involve filling out digital forms, attaching relevant documents, or providing validations, electronic signatures, as required by the specific Pactvera transaction. Following the completion of inputs and validations, signatures, the process may move to minting a data VDT. The VDT may serve as a cryptographic representation of the transaction data, ensuring its integrity and authenticity.

After minting the data VDT, the process may update the Pactvera. This update may incorporate the newly minted data VDT into the overall Pactvera transaction record. The process may then evaluate whether additional validation, signatures are needed. If more validation, signatures are required, the process may enter a wait state until all necessary validation, signatures are collected. This wait state may involve sending notifications to other parties or setting reminders for follow-up. If no additional validation, signatures are needed, the process may proceed to update the transactional VDT and transfer value. This step may involve executing smart contracts or triggering predefined actions based on the completed transaction. Following the value transfer, the Pactvera may be updated, marking it as complete with a Valitocurm designation. This final update may serve as a record of the successful execution of the Pactvera transaction. The process may conclude at a complete state, indicating that all necessary steps have been performed and the transaction has been fully executed. In some cases, the holder of the digital envoy and digital identity information may select which information to provide to someone seeking authentication of the individual. This selective disclosure may allow for privacy-preserving authentication, where only the necessary information is shared for a specific transaction or verification process.

A transaction can be illustrated using a point of sale (POS) transaction for this illustration and not to limit the invention, the process begins with two possible transaction initiation paths: a POS purchase where a credit card swipe occurs, or an online purchase where credit card information is entered during a credit card checkout. Following the transaction initiation, a phone notification can be sent to the cardholder's mobile device. The process then moves to a purchase validation, where the user provides authorization. A biometric scan is performed to verify the user's identity. In one example, the biometric scan can utilize the capture device to obtain biometric input from the user. The facial image module of the biometric data cloud can process facial recognition data to verify the user's identity. The transaction then flows through a BRE which evaluates conditions including identity, time, location, and token originality. The BRE can be configured to define specific criteria for transaction approval based on these factors. In one configuration, the BRE can interact with the blockchain storage to retrieve and verify the user's digital representation and associated metadata.

A location verification can be performed as part of the business rules evaluation. The location verification can utilize the metadata sequence stored in the database storage to confirm that the transaction location matches the user's expected location or falls within predefined acceptable parameters. Based on the evaluation by the BRE, the process can proceed to transaction authorization if all conditions are met. If conditions are not met, the process moves to transaction denial. In one example, the transaction system can interface with smart contracts deployed on the blockchain storage to enforce and implement the transaction policies. These smart contracts can define the conditions under which a transaction is considered valid and automatically approve or deny based on the verification results. The process includes updating a transaction ledger with the outcome. The transaction ledger can be stored in the immutable storage system, ensuring a secure and tamper-proof record of all transactions. In one configuration, the transaction ledger can allocate embedded token value among parties based on completion of assigned roles and successful compliance with rules defined in the business rules engine. Finally, the transaction result is passed back to either the POS system or eCommerce platform, depending on the original transaction type. This result can be transmitted through the network cloud to the appropriate client device or terminal and can be stored as a Valitorum.

The transaction authorization process integrates multiple components of the digital identity system, including biometric validation, blockchain-based data storage, and smart contract enforcement. This approach ensures robust transaction security while maintaining user privacy and enabling efficient processing of both in-person and online transactions.

The system's use of blockchain technology for storing transaction information and verification records offers significant advantages in terms of data integrity and immutability. Unlike traditional centralized databases, the distributed nature of blockchain makes it extremely difficult for malicious actors to alter or falsify identity records. This enhanced security helps protect against theft and fraud, which are growing concerns in the digital age.

Privacy preservation is another notable improvement offered by this system. By using tokenization and selective attribute disclosure, users can control which aspects of their identity are shared during verification processes. This granular control over personal information helps protect user privacy while still enabling effective identity verification for specific purposes.

The system's integration of biometric data and advanced processing techniques, such as facial recognition and fingerprint analysis, improves the accuracy and reliability of identity verification. These biometric factors, combined with other authentication methods, create a multi-layered approach to identity verification that is more robust than traditional password-based systems.

The system's ability to create and manage digital representations of transaction, physical documents and identities improves upon existing electronic signature technologies. By tying digital validation, signatures to verified digital identities and immutable blockchain records, the system provides a higher level of assurance in the authenticity of signed documents, the identity of signers and the implementation and enforcement of transactions.

In comparison to current technology, this system offers a more comprehensive and integrated approach to digital identity management. It combines secure storage, efficient verification, and user-controlled data sharing in a single ecosystem, addressing many of the limitations and fragmentation issues present in existing identity verification solutions.

The incorporation of geolocation data and temporal references in the verification process adds an additional layer of security not commonly found in traditional systems. This feature can help prevent unauthorized transactions attempts from unexpected locations or during unusual times, further enhancing the overall security of the system. By enabling anonymous identity validation through ChainIT ID, the system improves upon current methods of age verification and regulatory compliance. This feature allows businesses to confirm necessary attributes without exposing unnecessary personal information, striking a balance between regulatory requirements and user privacy.

Overall, the digital system represents a significant advancement in the field of transaction management and verification technology. Its combination of enhanced security measures, privacy-preserving features, and efficient verification processes addresses many of the challenges faced by current systems in the increasingly digital and interconnected world.

The verification system may include fraud prevention modules such as adaptive liveness detection, deepfake resistance technology, continuous biometric monitoring, behavioral authentication, and combinations thereof. The authority system may be a governmental entity recordation system adapted to provide creation authorization upon successful comparison of the digital representation with a governmental entity identity dataset. The verification system may be adapted to store the digital envoy on an immutable ledger.

The authority system may include a multi-tiered framework having government, enterprise, and decentralized identity providers, and may be adapted for real-time fraud detection using machine learning based anomaly detection. The verification system may create a ChainIT ID according to smart contract-based identity validation or geofenced authentication validation. The system may be adapted to identify and store relationships between ChainIT IDs and ChainIT Org IDs. The ChainIT ID may be adapted to verify transactions in real-time using biometric confirmation.

The system may include fallback authentication processes such as one-time cryptographic challenges, secondary multi-modal biometric confirmation, adaptive risk-based verification, hardware-token authentication, and out-of-band identity verification. The verification system may include logs for auditing and regulatory oversight stored on an immutable ledger.

In the event of system-level exceptions or biometric validation failures, the system shall generate an immutable ‘Audit Pending’ state, prompting manual review and secondary verification to ensure continuity and admissibility.

The system creates a unique tokenized representation by combining multiple layers of data processing and cryptographic techniques. Initially, it captures biometric information from an individual using specialized hardware. This raw biometric data undergoes advanced processing through modules in the biometric data cloud, transforming it into a standardized digital format. The system then applies cryptographic hashing algorithms to this processed data, generating a unique identifier that serves as the core of the digital representation. This identifier is further enhanced by incorporating additional metadata, such as timestamps and geolocation data, to create a comprehensive digital envoy. The resulting tokenized representation is then encrypted and stored on an immutable ledger, such as a blockchain, ensuring its integrity and allowing for secure, verifiable access in future authentication processes.

Examples of the system use:

A contractor and a property owner execute a transaction for renovation services. The contractor's ChainIT ID, validated via biometrics and device signature, creates the transaction including a VDT of the service to be provided. The property owner, a business entity, uses a pre-executed ARP to attest acceptance with organizational authority. The transaction includes a TCA representing escrow funds. Upon completion of the work and successful inspection validated through a third party's ChainIT ID, the escrow TCA is automatically transferred, with the service VDT, to include any warranty which is also connected to the property and contractor, is transferred and the transaction finalized into a Valitorum, archived for both parties, recorders, and regulators.

The system may incorporate a payment value directly into the tokenized representation, enhancing its functionality beyond identity verification. This embedded value can be allocated among various parties based on their roles and compliance with predefined rules within the business logic engine. By integrating payment information into the token structure, the system enables seamless financial transactions tied to identity verification events. This approach may allow for automated disbursement of funds upon successful completion of specific verification steps or contractual obligations, potentially streamlining processes such as escrow services or performance-based payments. The embedded payment value can be cryptographically secured within the token, maintaining the overall security and integrity of the digital identity system while adding a layer of financial capability to the verification process.

The system may verify signers through a multi-step process that combines biometric authentication with decentralized digital identification. When a signer initiates a verification request, the capture device may collect biometric data such as facial features, fingerprints, or voice patterns. This raw biometric information may then be processed by specialized modules within the biometric data cloud, converting it into a standardized digital format. The system may compare this processed biometric data against the digital representation associated with the signer's unique digital envoy, which is securely stored on an immutable ledger. If the biometric data matches the stored digital representation, the system may generate a positive verification result. This process may occur in real-time, allowing for swift and secure authentication of signers without relying on centralized databases or traditional identity documents. The use of blockchain technology and cryptographic techniques may ensure the integrity and immutability of the verification process, while also allowing signers to maintain control over their personal information through selective attribute disclosure.

The system may utilize smart contracts deployed on the blockchain to manage conditional payments to signers based on predefined criteria. When specific conditions are met, such as successful identity verification, adherence to temporal constraints, geolocation matching, and confirmation of token authenticity, the smart contract may automatically trigger the release of funds. This process can leverage the embedded payment value within the tokenized representation, allowing for seamless and trustless disbursement of compensation to one or more signers. The business rules engine may evaluate these factors in real-time, ensuring that all conditions are satisfied before authorizing the payment. This approach may enhance efficiency and reduce the need for intermediaries in complex multi-party agreements, while maintaining the security and integrity of the transaction through cryptographic verification and immutable record-keeping on the blockchain.

The Pactvera system ensures enforceability not through reliance on post-hoc document review, but by incorporating all required elements of contract law—offer, acceptance, mutual assent, consideration, legality, and capacity—into the tokenized record at the time of validation. These conditions are verified through BRE logic at the moment of Pactvera Validation, and only then is the Pactvera finalized as a Valitorum. This guarantees that every Valitorum is legally binding and court-defensible at the moment it is created.

The invention includes enhanced compliance with the Uniform Real Property Electronic Recording Act (URPERA) through mechanisms that ensure data integrity, non-repudiation, and accessibility. Every Pactvera used in real property contexts is accompanied by a cryptographic seal (hash of content, timestamp, identity), and is stored in formats meeting statutory longevity and auditability. Metadata includes recorder ID, jurisdictional tag, and notarial equivalency evidence (i.e., biometric verification timestamped with geo-coordinates).

As used herein, the term “module” may refer to a functional unit or component of the system that can be implemented in hardware, software, firmware, or a combination thereof. A module may perform specific tasks or functions within the overall system architecture. For example, a module may include processing logic, data storage, communication interfaces, or specialized algorithms designed to carry out particular operations related to digital transaction creation, validation, or execution. Modules may be designed to be interoperable and may communicate with other modules within the system to exchange data or trigger actions. In some aspects, modules may be configurable or customizable to adapt to different use cases or requirements. The system may comprise multiple interconnected modules working together to provide the full range of functionality described in the claims.

It is understood that the above descriptions, examples, and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized method of recording digital transactions directed to real property comprising:
verifying a signer identity using a digital identity;
associating a geolocation, a timestamp;
a device metadata and any combination thereof with a validation of the digital transaction;
minting a validated data token with a hashed digital transaction;
submitting the digital transaction to an electronic recorder system; and
recording a proof-of-record event to an immutable ledger in compliance with a current Uniform Real Property Electronic Recoding Act (URPERA).

2. The computerized method of claim 1 including:
verifying the digital transactions using liveness-confirmed biometric authentication, timestamp, and geolocation data;
embedding a participant role, authorization, and intent in metadata associated with the digital transaction; and
associating the metadata with the digital transaction token to provide a substitute for traditional notarization in compliance with URPERA, E-Sign Act, and Uniform Electronic Transactions Act.

3. A system for executing and recording Pactveras under a Uniform Real Property Electronic Recording Act (URPERA), comprising:
a decentralized identity verification system that confirms the identity and authority of an attesting party through biometric ChainIT ID and organizational credentials;
a geolocation and timestamp capture module for verifying jurisdiction and date of a Pactvera validation;
a document tokenization engine that generates a unique non-fungible token for the Pactvera, containing a cryptographic hash of a content and originator identification;
a Pactvera validation engine that records a signer metadata including age, authority, location, and device identification;
a compliance module that ensures the Pactvera satisfies statutory elements of offer, acceptance, consideration, capacity, and legality;
an immutable ledger event log for recording the Pactvera and its metadata; and
a recorder integration application programming interface enabling submission of the Pactvera and metadata to an electronic recording system in compliance with URPERA.

4. A computerized method for creating and executing a Pactvera comprising steps for:
receiving transaction information;
generating a tokenized representation of the transaction;
embedding a digital consideration into the tokenized representation;
verifying identities of a participant;
recording transaction metadata;
validating transaction conditions using a business rules engine;
storing the tokenized representation on an immutable ledger;
executing the Pactvera upon satisfaction of predefined conditions; and
generating a verifiable digital record of the executed Pactvera.

5. A system for creating and executing a Pactvera comprising:
a computerized system in communications with a remote computer system, an immutable ledger, an identity verification system and a consideration transfer system having:
a transaction creation module configured to receive transaction information from a creator using a remote computer system adapted for receiving transaction information from the creator;
a tokenization module configured to generate a unique tokenized representation of the transaction using a non-fungible token standard to create a Pactvera;
a consideration module configured to embedding a digital consideration into the tokenized representation;
an identity verification module configured to verifying identities of a participant through biometric authentication and decentralized identity validation using an identity verification system;
a metadata recording module configured to recording transaction metadata including time, location, device identification, and jurisdiction;
a validating module configured to validate transaction conditions using a business rules engine;
a storage module configured to store the tokenized representation and associated metadata on the immutable ledger;
an execution module configured to execute the Pactvera upon satisfaction of predefined conditions; and
a record generation module configured to generate a verifiable digital record of the executed transaction.

6. A digital system comprising:
a digital device adapted for:
generating a Pactvera using a secure capture and verification system that authenticates identity through biometric data, geolocation, device ID, and immutable ledger recordation;
minting a tokenized representation of the Pactvera as a non-fungible token;
capturing a signer metadata at a time of execution; and
ensuring that the metadata and digital signature are sufficient to meet an attribution, integrity, and enforceability standards under a Uniform Real Property Electronic Recording Act, including requirements for integrity, auditability, and confirmation of a signatory's authority.

7. A computerized method for digitally executing a legally binding Pactvera comprising:
capturing an offer and acceptance exchange between two or more participants to a transaction;
validating mutual assent and legal capacity through biometric verification and ChainIT ID;
verifying consideration by embedding a consideration in the Pactvera;
confirming legality and jurisdiction using a business rules engine that validates location, age, and governing law; and
recording the Pactvera as a Valitorum on an immutable ledger only upon fulfillment of all legal contract elements.

8. A computerized system for executing a Pactvera comprising:
a Pactvera token representing an agreement associated with a transaction;
a consideration comprising monetary value or a VDT associated with the transaction;
a smart contract engine actuated by a successful Pactvera validation condition including identity, location, device, time, and token originality; and
a settlement protocol adapted to transfer the consideration to a designated participant upon verification of compliance with a business rules engine.

9. The computerized system of claim 8 comprising:
a computer device adapted for:
validating an authority of a participant to a Pactvera validation on behalf of an organization using an authority resolution pactvera (ARP) wherein said ARP is executed by one or more biometric verified individuals associated with the organization; and
wherein the authority can be queried and verified prior to or during the Pactvera validation using a ChainIT Org ID system.

10. A computerized method for providing immutable authorship and origin of a Pactvera, comprising:
generating a Pactvera using a verified ChainIT ID that includes biometric validation and authoritative source confirmation;
embedding a creator's identity, geolocation, device metadata, and jurisdiction at a moment of creation in a Pactvera token;
recording the metadata within the Pactvera token and publishing it to an immutable ledger; and
providing cryptographically verifiable proof of authorship and origin to a third party.

11. A computerized method for digitally forming and validating a legally enforceable Pactvera, comprising:
capturing and recording a digital offer initiated by a first participant, including terms, roles, and scope of agreement;
capturing a corresponding acceptance by a second participant through biometric authentication and ChainIT ID validation;
embedding consideration into the Pactvera as a monetary value, a digital asset, a validated data token and any combination thereof, verifiably exchanged by both participants;
verifying that each participant has a legal capacity by checking biometric age markers, verified government records, and jurisdictional majority thresholds;
ensuring legality of purpose through a business rules engine evaluation of a Pactvera object against jurisdictional and regulatory information;
capturing metadata including timestamp, device ID, and geolocation to establish enforceability, jurisdiction, and legal compliance;
recording a completed and validated Pactvera as a Valitorum on an immutable ledger; and,
certifying an inclusion and satisfaction of each required legal element of contract formation.

12. A computerized system for validating a legal enforceability of a Pactvera prior to execution, comprising:
a compliance engine configured for:
parsing a Pactvera structure for offer and acceptance metadata;
validating a mutual assent through synchronized ChainIT ID verification events;
verifying an inclusion of consideration using embedded VDTs or programmable value;
assessing a signer capacity based on age, legal status, and biometric identity;
screening for a legality of subject matter through a business rules engine; and,
authorizing an execution upon successful validation of an element of legal contract formation.

13. A computerized method for validating organizational authority to execute a Pactvera, comprising:
generating an authority resolution pactvera (ARP) that includes:
biometric identity of individuals authorized by an organization through an authorizing the resolution;
capturing timestamp, geolocation, and device metadata at a time of execution;
using ChainIT Org ID as an issuing entity's identity anchor;
tokenizing the ARP as a non-fungible record stored on an immutable ledger;
referencing the ARP during a future Pactvera validation attempt by affiliated participants;
validating the executing individual's identity, role, and authority via comparison to the ARP record; and
recording an organizational Pactvera validation event upon successful matching to a valid ARP.

14. A computerized system for maintaining and validating organizational authority for Pactvera execution, comprising:
an authority resolution pactvera (ARP) registry containing tokenized resolutions executed by a representative officers or shareholders of an entity using biometric ChainIT ID;
a verification engine adapted to query a ARP ledger for matching identity, title, and authorization scope;
a smart contract interface adapted to block or approve Pactvera execution by an individual claiming to act on behalf of an organization based on ARP match; and
an audit module adapted to generate cryptographically verifiable proof of authority lineage, authorship, and timing for regulatory inspection.

15. The computerized system of claim 14 wherein ARP satisfies legal requirements for board resolutions, partnership consents, and internal authorizations requiring written or notarized approval; and
the ARP is recognized as valid by receiving systems, title insurers, auditors, public entities and any combination through a ChainIT application programming interface lookup and cryptographic hash verification.

16. A computerized method for representing and disbursing consideration associated with a Pactvera, comprising:
generating a tokenized consideration asset (TCA) represented as a non-fungible token;
embedding the TCA into a Pactvera at a time of execution, wherein the TCA represents a monetary value, an access to a service, a right to a physical good, a verified entitlement or license and any combination thereof;
defining conditional logic for transfer of the TCA using a business rules engine (BRE); and,
releasing the TCA to one or more beneficiaries upon fulfillment of BRE conditions and successful Pactvera validation by a participant.

17. The computerized method of claim 16 including:
a validated data token (VDT) that represents an authenticated event, record, or verification related to a physical or digital object associated with the Pactvera;
and the TCA represents a transferrable item of value that serves as consideration for a contractual formation associated with the Pactvera; and
wherein each VDT and TCA is cryptographically linked to the Pactvera and recorded on an immutable ledger.

18. The computerized method of claim 16 wherein the TCA is are independently tradable in a secondary marketplace and the TCA includes metadata reflecting its origin, associated Pactvera, transfer history, and redemption status.

19. A computerized method of controlling Pactvera execution using a programmable business rules engine, comprising:
defining an execution condition including signer identity, geographic location, timestamp, token originality, signer capacity, and authority;
encoding the execution condition into a logic framework linked to the Pactvera;
evaluating whether the execution condition is satisfied using real-time metadata collected during Pactvera validation;
preventing Pactvera finalization if any condition is unmet; and triggering a smart contract-based actions, including a disbursement of value of a Valitorum, upon compliance with the execution condition of the Pactvera.

20. A computerized system for managing Pactvera lifecycle events using dynamic rule evaluation, comprising:
a business rules engine configured to:
monitor transaction metadata against pre-defined or dynamically generated legal and business rules;
calculate eligibility for execution, transfer, or dispute resolution; and.
a smart contract interface configured to:
execute programmable Pactvera actions including fund release, TCA transfer, or escrow activation;
enforce time-based or jurisdictional conditions automatically wherein said system generates and immutably records decision-state evidence for legal or regulatory inspection.

21. The computerized system of claim 20 comprising:
a failsafe logic layer configured to:
reject Pactvera execution if signer identity is incomplete, expired, or revoked;
halt execution if geolocation falls within a restricted jurisdiction;
suspend automated actions if attestation occurs outside a defined temporal window; and
log all such exceptions as immutable rejection events linked to an associated ChainIT ID.

22. A computerized method of generating and submitting a Pactvera for real property recording under a Uniform Real Property Electronic Recording Act (URPERA), comprising:
verifying a signer's identity using biometric authentication through ChainIT ID;
associating real-time metadata including timestamp, geolocation, and device ID with a Pactvera validation;
generating a hashed representation of the Pactvera as a non-fungible token;
tagging the Pactvera with jurisdictional metadata compliant with county or state recorder requirements;
submitting an electronic Pactvera via an application programming interface to a URPERA-compliant recorder system; and
recording a proof-of-record event on an immutable ledger as legal evidence of execution and submission.

23. A computerized system for substituting physical notarization with digital Pactvera validation in compliance with Uniform Real Property Electronic Recording Act (URPERA) comprising:
a biometric capture interface that validates signer liveness and identity;
an attestation capture module that records location, timestamp, signer capacity, and ChainIT ID;
an authorization validator that ensures a signer's role, intent, and legal authority are stored in immutable metadata; and
a notarization equivalency module that encodes and stores the Pactvera as a legally admissible digital record under URPERA.

24. A computerized system for generating recorder-specific metadata for submission under Uniform Real Property Electronic Recording Act comprising:
a jurisdiction engine that determines applicable county or state regulations based on geolocation;
a metadata template module that formats data in recorder-compatible structures;
and an immutable audit trail system that links an original signer, their ChainIT ID, location, device ID, timestamp, and role to a Pactvera token.

25. A computerized method for generating a Valitorum from a Pactvera execution comprising:
capturing a Pactvera validation metadata including signer identity, location, time, device ID, and token grade;
verifying each participant's authority and capacity through ChainIT ID and authority resolution transaction;
satisfying execution conditions through a business rules engine;
generating a non-fungible token encapsulating all Pactvera terms, authorship, and validation proofs; and
recording an output token as a Valitorum, indicating final, immutable, and enforceable status.

26. The computerized method of claim 25, wherein the Valitorum is used as legal evidence of contract formation, assent, and consideration, includes jurisdictional tags and signer authority metadata for compliance under Uniform Real Property Electronic Recording Act (URPERA) and is accepted by recorder application programming interfaces or judicial review interfaces as a substitute for wet ink signatures or notarized documents.

27. A computerized method for handling execution anomalies in a Pactvera system, comprising:
detecting a system level exception, biometric failure, data input anomaly, or device malfunction during Pactvera validation or execution;
generating an immutable Audit Pending state on an immutable ledger indicating the anomaly;
triggering a manual review process requiring secondary verification by authorized personnel;
allowing conditional override of a Pactvera execution status upon successful human validation, provided such override is logged immutably and complies with predefined evidentiary and admissibility standards under a ChainIT platform policy and applicable legal frameworks.

28. The computerized method of claim 27, wherein the manual override process includes biometric re-verification by an original signer and dual attestation by organizational authorities.
